(19) United States
(12) Patent Application Publication
(10) Pub. No.: US 2026/0039485 A1
(43) Pub. Date: Feb. 5, 2026

(54) MULTI-BIT MEMORY-BASED PHYSICALLY UNCLONABLE FUNCTION

(71) Applicant: University of Florida Research Foundation, Incorporated, Gainesville, FL (US)

(72) Inventors: Swarup Bhunia, Gainesville, FL (US); Atri Chatterjee, Gainesville, FL (US); Peyman Dehghanzadeh, Gainesville, FL (US)

(21) Appl. No.: 19/283,915

(22) Filed: Jul. 29, 2025

Related U.S. Application Data
(60) Provisional application No. 63/677,601, filed on Jul. 31, 2024.

(51) Int. Cl. H04L 9/32

(52) U.S. Cl. CPC H04L 9/3278

(57) ABSTRACT

An apparatus comprising a pair of inverters configured in a cross-coupled configuration, wherein an inverter of the pair of inverters comprises a static random-access memory (SRAM) physically unclonable function (PUF) circuit, wherein the SRAM PUF circuit comprises an inverter; and an inverter cell comprising a p-channel metal-oxide-semiconductor (PMOS) transistor, an n-channel metal-oxide-semiconductor (NMOS) transistor, and output node, and a control signal input, wherein: (i) the PMOS transistor comprises (a) a drain terminal that is coupled to an output and (b) a source terminal that is coupled to a supply voltage, (ii) the NMOS transistor comprises a gate terminal that is coupled to a gate of the PMOS transistor that inhibits a path between the supply voltage and ground, and (iii) responsive to a low state provided to the control signal input, the control signal input causes the PMOS transistor to charge the output node to the supply voltage.

### CROSS REFERENCE TO RELATED APPLICATION

This application claims the priority of U.S. Provisional Application No. 63/677,601, entitled “MULTI-BIT MEMORY-BASED PHYSICALLY UNCLONABLE FUNCTION,” filed on Jul. 31, 2024, the disclosure of which is hereby incorporated by reference in its entirety.

### BACKGROUND

Traditional static random-access memory (SRAM) physically unclonable functions (PUFs) may provide a simple approach to hardware security by leveraging the inherent variations present in SRAM cells to generate unique and unpredictable identifiers. These identifiers may serve as a basis for authentication and cryptographic key generation, which may be used to establish trust and safeguard sensitive information in various electronic systems. For example, SRAM PUFs may exploit manufacturing variations in SRAM cells to exhibit distinct power-up states suitable for generating PUF responses. PUF response patterns may be deterministic yet unpredictable and thereby may be resistant to cloning and tampering attempts. However, traditional SRAM PUFs are susceptibility to environmental noise and various attacks, such as modeling, simulation, and emulation attacks. Thus, there is a need for addressing critical issues inherent to SRAM PUF cells.

### BRIEF SUMMARY

Various embodiments described herein relate to methods, apparatus, systems, computing devices, computing entities, and/or the like for improving the performance of memory-based physically unclonable functions.

According to some embodiments, an apparatus comprises a pair of inverters that are configured in a cross-coupled configuration, wherein an inverter of the pair of inverters comprises a static random-access memory (SRAM) physically unclonable function (PUF) circuit, wherein the SRAM PUF circuit comprises an inverter; and an inverter cell comprising a p-channel metal-oxide-semiconductor (PMOS) transistor and an n-channel metal-oxide-semiconductor (NMOS) transistor, wherein (i) the PMOS transistor comprises (a) a drain terminal that is coupled to an output and (b) a source terminal that is coupled to a supply voltage, (ii) the NMOS transistor comprises a gate terminal that is coupled to a gate of the PMOS transistor that inhibits a path between the supply voltage and ground, and (iii) responsive to a low state provided to a control signal input, the control signal input causes the PMOS transistor to charge an output node to the supply voltage.

According to some embodiments, an apparatus comprises a pair of multiplexers, wherein (i) a first multiplexer of the pair of multiplexers comprises a first set of multiplexer inputs, a first multiplexer output, and a first select input and (ii) a second multiplexer of the pair of multiplexers comprises a second set of multiplexer inputs, a second multiplexer output, and a second select input; a first set of inverters comprising (i) a first set of inverter inputs that is coupled to the second multiplexer output and (ii) a first set of inverter outputs that is coupled to the first set of multiplexer inputs; and a second set of inverters comprising (i) a second set of inverter inputs that is coupled to the first multiplexer output and (ii) a second set of inverter outputs that is coupled to the second set of multiplexer inputs.

In some embodiments, a challenge is applied to the first select input or the second select input. In some embodiments, the challenge comprises a select signal value that corresponds to a selection of a first inverter from the first set of inverter inputs and a second inverter from the second set of inverter inputs. In some embodiments, the first inverter and the second inverter are configured to generate a physically unclonable function (PUF) response that corresponds to the challenge. In some embodiments, the challenge comprises a length that corresponds to a quantity of inverters in the first set of inverters or the second set of inverters.

In some embodiments, an inverter of the first set of inverters or the second set of inverters comprises a static random-access memory (SRAM) PUF circuit, wherein the SRAM PUF circuit comprises a transistor inverter circuit; and an inverter cell comprising a p-channel metal-oxide-semiconductor (PMOS) transistor and an n-channel metal-oxide-semiconductor (NMOS) transistor, wherein (i) the PMOS transistor comprises (a) a drain terminal that is coupled to an output and (b) a source terminal that is coupled to a supply voltage, (ii) the NMOS transistor comprises a gate terminal that is coupled to a gate of the PMOS transistor that inhibits a path between the supply voltage and ground, and (iii) responsive to a low state provided to a control signal input, the control signal input causes the PMOS transistor to charge an output node to the supply voltage. In some embodiments, the inverter further comprises a first multiplexing transistor and a second multiplexing transistor, wherein (i) the first multiplexing transistor comprises a first multiplexing transistor source terminal that is coupled to a drain terminal of the NMOS transistor and (ii) the second multiplexing transistor comprises a second multiplexing transistor drain terminal that is coupled to the transistor inverter circuit. In some embodiments, the inverter further comprises a first select transistor and a second select transistor that are configured to provide a select signal to the second multiplexing transistor. In some embodiments, the second multiplexing transistor comprises a second multiplexing transistor gate terminal that is coupled to (i) a first select transistor source terminal of the first select transistor and (ii) a second select transistor drain terminal of the second select transistor. In some embodiments, the inverter further comprises a select signal that is coupled to (i) a first multiplexing transistor gate terminal of the first multiplexing transistor, (ii) a first select transistor gate terminal of the first select transistor, and (iii) a second select transistor gate terminal of the second select transistor. In some embodiments, the inverter further comprises an inverter activation system and a primitive pre-conditioning system. In some embodiments, the inverter activation system corresponds to functionality of the transistor inverter circuit via the first multiplexing transistor and the second multiplexing transistor based on the select signal. In some embodiments, the primitive pre-conditioning system comprises a pull-up pin that is configured to (i) force the output node to the supply voltage or (ii) isolate the output node from the supply voltage. In some embodiments, the primitive pre-conditioning system comprises a pull-down pin that is configured to (i) force the output node to the ground or (ii) isolate the output node from the ground.

According to some embodiments, an apparatus comprises an edge-triggered D flip-flop comprising a set of NAND gates that are configured in a cross-coupled configuration; a pair of D-latch NAND gates; and a pair of multiplexers that are configured in between the set of NAND gates and the pair of D-latch NAND gates, wherein a multiplexer of the pair of multiplexers comprises a multiplexer output that is coupled to a first D-latch NAND input of a first D-latch NAND gate of the pair of D-latch NAND gates; a first multiplexer input that is coupled to a NAND output from the set of NAND gates, a second multiplexer input that is coupled to (a) a second D-latch NAND input of the first D-latch NAND gate and (b) a D-latch NAND output of a second D-latch NAND gate of the pair of D-latch NAND gates, and a control signal that configures operation of the edge-triggered D flip-flop.

### BRIEF DESCRIPTION OF THE DRAWINGS

Embodiments incorporating teachings of the present disclosure are shown and described with respect to the figures presented herein.

FIG. 1A is an example gate-level circuit diagram of a static random-access memory (SRAM) physically unclonable function (PUF).

FIG. 1B is an example transistor-level circuit diagram of a SRAM PUF.

FIG. 2 is a schematic diagram of an example SRAM PUF circuit in a noisy environment.

FIG. 3A is a transistor level diagram of an example inverter.

FIG. 3B is a gate level diagram of a modified SRAM PUF cell in accordance with some embodiments of the present disclosure.

FIG. 4A and FIG. 4B are transistor level diagrams of example modified inverters in accordance with some embodiments of the present disclosure.

FIG. 5A is a transistor level diagram of a modified SRAM PUF in accordance with some embodiments of the present disclosure.

FIG. 5B is a gate level diagram of a modified SRAM PUF in accordance with some embodiments of the present disclosure.

FIG. 6 is a schematic diagram of a strong memory-based PUF in accordance with some embodiments of the present disclosure.

FIG. 7A is a transistor level diagram of a modified inverter in accordance with some embodiments of the present disclosure.

FIG. 7B is a gate level diagram of a modified inverter in accordance with some embodiments of the present disclosure.

FIG. 8 is a gate level diagram of an example strong memory-based PUF in accordance with some embodiments of the present disclosure.

FIG. 9 is a transistor level diagram of a modified inverter in accordance with some embodiments of the present disclosure.

FIG. 10A is a transistor level diagram of a modified inverter that is configured for pre-charging during a pre-conditioning phase in accordance with some embodiments of the present disclosure.

FIG. 10B is a transistor level diagram of a modified inverter that is configured for pre-charging during a post-conditioning phase in accordance with some embodiments of the present disclosure.

FIG. 11A is a transistor level diagram of a modified inverter that is configured for pre-draining during a pre-conditioning phase in accordance with some embodiments of the present disclosure.

FIG. 11B is a transistor level diagram of a modified inverter that is configured for pre-draining during a post-conditioning phase in accordance with some embodiments of the present disclosure.

FIG. 12 is a component diagram of an example edge-triggered D flip-flop with a NAND gate implementation.

FIG. 13 is a component diagram of an example modified edge-triggered D flip-flop circuit in accordance with some embodiments of the present disclosure.

FIG. 14A is a gate level diagram of an example flip-flop circuit operating in an edge-triggered D flip-flop mode in accordance with some embodiments of the present disclosure.

FIG. 14B is a gate level diagram of an example flip-flop circuit operating in a PUF mode in accordance with some embodiments of the present disclosure.

FIG. 15 is a component diagram of an example NAND gate in accordance with some embodiments of the present disclosure.

FIG. 16 is a transistor level diagram of an example modified NAND gate in accordance with some embodiments of the present disclosure.

FIGS. 17 and 18 are schematics of example FPGA platforms in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

Integrating security features, such as physically unclonable functions (PUFs), into a semiconductor die and design may pose challenges for manufacturers and design owners. For example, concerns may pertain to additional area overhead and costs associated with implementing such security primitives. That is, traditional approaches often require dedicated hardware resources, leading to increased chip area utilization and manufacturing expenses. The presently disclosed multibit memory-based PUF (MBM-PUF) provides a solution to the aforementioned challenges. An advantage provided by the disclosed MBM-PUF may comprise an ability to utilize existing resources efficiently. By incorporating a PUF mechanism within existing building blocks, such as flip-flops or latches, a need for dedicated hardware components to implement a security feature may be eliminated, thereby minimizing area overhead. As such, the disclosed MBM-PUF may facilitate a circuit design process that is streamlined and provide reduced manufacturing costs. Accordingly, the disclosed MBM-PUF may provide a cost-effective solution for integrating robust security features into semiconductor designs. Furthermore, the disclosed MBM-PUF may provide flexibility to enable adaptation to diverse design requirements without compromising on security or performance. Accordingly, the disclosed MBM-PUF may be seamlessly integrated into a plurality of applications ranging from small-scale embedded systems to complex multi-core processors and offer robust protection against various security threats.

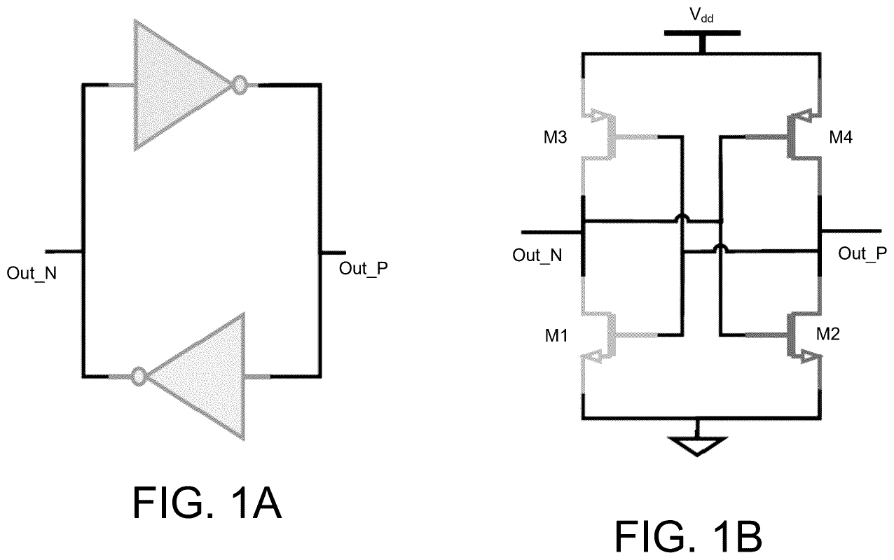

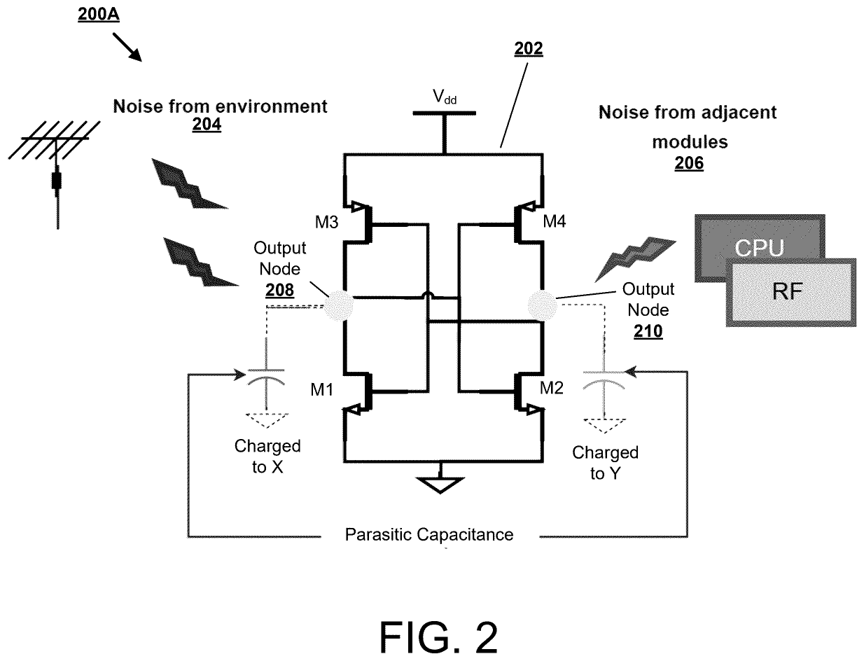

Various embodiments of the present disclosure may provide enhancements to traditional static random-access memory (SRAM) PUFs. FIG. 1A is an example gate-level circuit diagram of a SRAM PUF and FIG. 1B is an example transistor-level circuit diagram of a SRAM PUF. SRAM PUFs may offer advantages, such as low hardware overhead, fast response times, and reconfigurability. Supply voltage V_{dd} SRAM PUFs may also be used to provide hardware security that is based on process variations that occur naturally during semiconductor production of SRAM cells. As such, SRAM PUF cells may facilitate a high level of security and robustness against cloning and tampering attempts.

However, traditional SRAM PUFs may also possess several disadvantages, such as susceptibility to environmental variations and aging effects, which may degrade the reliability and stability of generated keys over time. Additionally, traditional SRAM PUFs may be vulnerable to modeling attacks, where adversaries attempt to reverse-engineer the underlying physical characteristics to replicate PUF responses, compromising the security of a system. Furthermore, limited entropy and reliability of traditional SRAM cells may lead to challenges in achieving consistent and robust authentication performance, especially in harsh operating conditions or in the presence of malicious adversaries. Such drawbacks may accentuate a need for developing techniques to enhance the resilience and security of traditional SRAM PUFs for practical deployment in real-world applications.

Given the simplicity of implementation and numerous advantages of traditional SRAM PUFs, it may be advantageous to address the drawbacks of traditional SRAM PUFs. By enhancing the resilience and security of SRAM PUFs, techniques disclosed herewith may mitigate vulnerabilities, such as susceptibility to environmental variations, aging effects, and modeling attacks. According to various embodiments of the present disclosure, SRAM PUFs may be augmented with additional mechanisms to increase their entropy, improve reliability, and strengthen resistance against adversarial exploits. By fortifying SRAM PUFs through the disclosed techniques, SRAM PUFs may be more feasible to be deployed in critical applications where robust authentication and cryptographic security may be desired.

### Example System Architecture

According to various embodiments of the present disclosure, an MBM-PUF may comprise modified SRAM PUFs as foundational components.

### Enhanced Resilience Against Environmental Interference

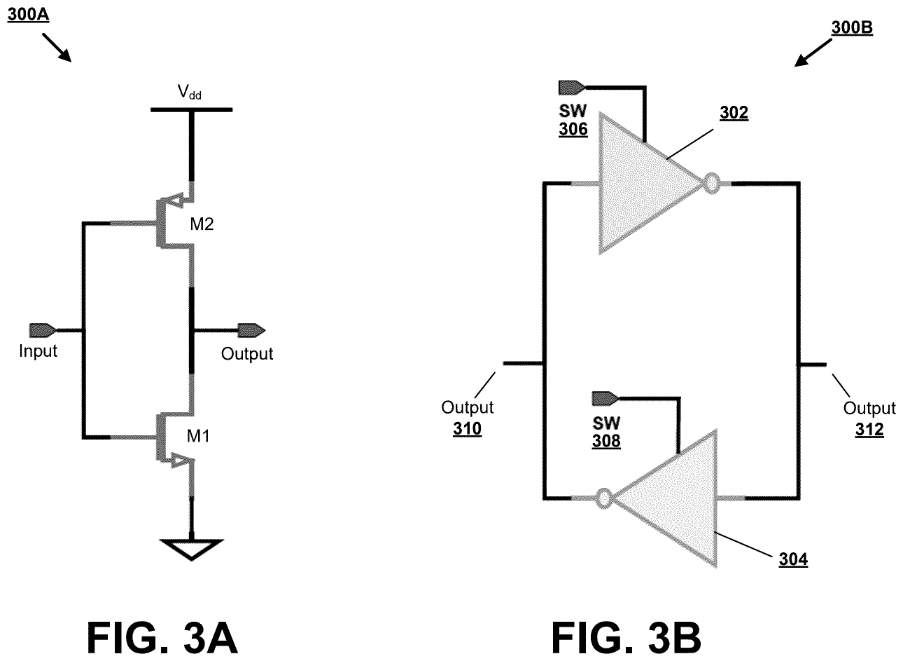

FIG. 2 is a schematic diagram of an example SRAM PUF circuit 200 in a noisy environment. A SRAM PUF 202 may exhibit response uncertainty attributed to uneven charge accumulation from environmental noise (204) or noise from adjacent modules (206) prior to a power-up state. For example, if one or more distributed SRAM cells are situated in close proximity to other components, such as metal traces from upper layers, capacitors, inductors, or any elements capable of inducing charge fluctuations into output nodes, induced charges may potentially raise or lower voltage levels at the output nodes, consequently disrupting an equilibrium between output nodes 208 and 210 prior to power-up state. Such disruptions may exceed the inherent process variation within the SRAM structure, resulting in a change in an ultimate PUF response and may potentially undermine the consistency and reliability of an SRAM PUF's performance.

To mitigate uncertainty stemming from induced charges on the output nodes of SRAM cells, induced charges on output nodes may need to be controlled or regulated to a predetermined value before the power-up state. As such, the charge accumulated on a pair of floating nodes may be precisely matched or set to a predetermined value before entering the power-up state. A balance of charges may be essential for preserving PUF outputs that rely on process variations, without being susceptible to external noise influences. Adhering to such a practice may ensure the stability and uniformity of PUF responses, enhancing their reliability and resilience against external disruptions.

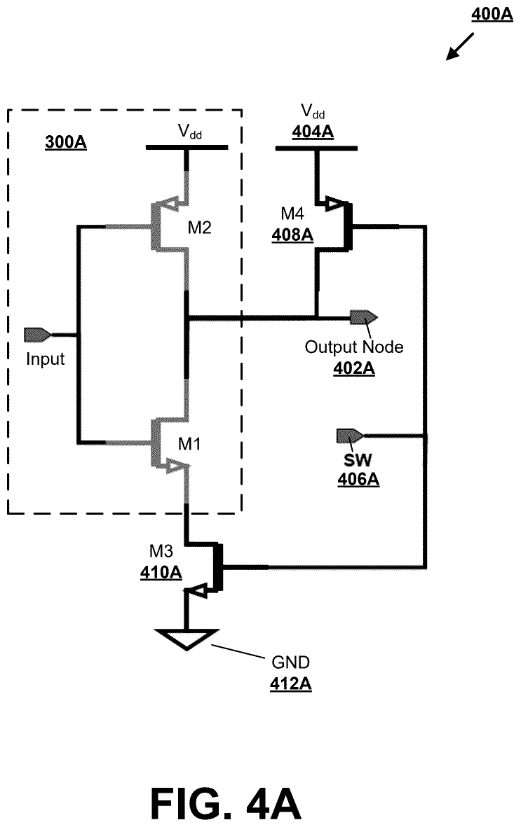

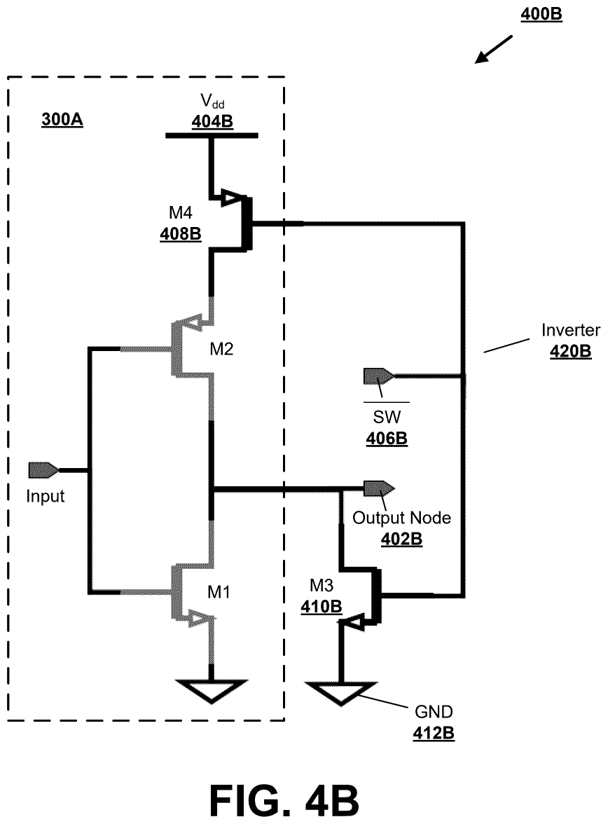

FIG. 3A is a transistor level diagram of an example inverter 300A. To ensure uniformity in the charges on floating nodes and to provide precise definition, adjustments may be made to the inverter 300A, which may be employed within an inverter cell. One such modification may comprise an additional input (SW), which may be configured to delincate two distinct operational states of the inverter cell. The additional input may allow for a transition between an equilibration phase and an evaluation phase. The boundary between the equilibrium and evaluation phases may be demarcated by the transition of SW signal from a LOW state to a HIGH state.

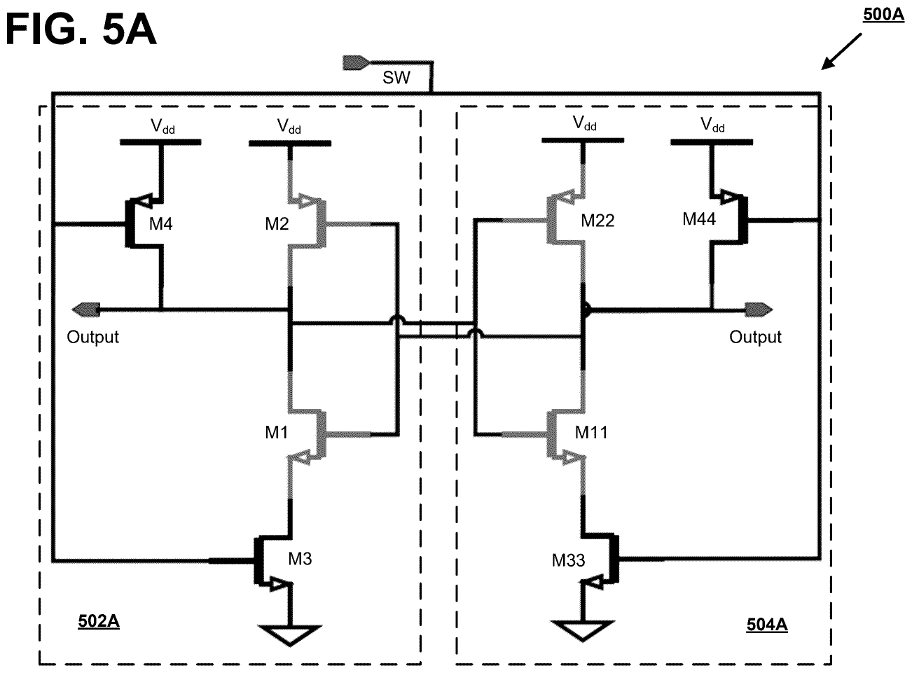

FIG. 3B is a gate level diagram of a modified SRAM PUF cell 300B in accordance with some embodiments of the present disclosure. As depicted in FIG. 3B, the modified SRAM PUF cell 300B comprises two modified inverters 302 and 304 featuring corresponding SW inputs 306 and 308. In some embodiments, charges at outputs 310 and 312 are balanced in the equilibration phase by using modified inverters depicted in FIG. 4A or FIG. 4B.

FIG. 4A is a transistor level diagram of a modified inverter 400A in accordance with some embodiments of the present disclosure. The modified inverter 400A pulls output node 402A up to supply voltage (V_{dd}) 404A. As depicted in FIG. 4A, output node 402A and its associated parasitic capacitance are charged to V_{dd} 404A when control signal input SW 406A is in a LOW state. A drain terminal of a p-channel metal-oxide-semiconductor (PMOS) transistor M4 408A is connected to the output node 402A and the source terminal of the PMOS transistor M4 408A is connected to V_{dd} 404A. The control signal input SW 406A in a LOW state causes the PMOS transistor M4 408A to actively charge output node 402A to V_{dd} 404A. To prevent short-circuit between the power supply rails, n-channel metal-oxide-semiconductor (NMOS) transistor M3 410A is incorporated (the gate terminal of transistor M3 410A is connected to the gate terminal of transistor M4 408A) coupled in such a way as to eliminate a direct path between V_{dd} 404A and ground (GND) 412A.

FIG. 4B is a transistor level diagram of a modified inverter 400B in accordance with some embodiments of the present disclosure. The modified inverter 400B pulls output node 402B down to GND 412B. The output node 402B discharges to GND 412B when S̅W̅ 406B is in a HIGH state (or when signal SW is in a LOW state). Such may be achieved through the utilization of NMOS transistor M3 410B, with its drain terminal connected to the output node 402B, and its source terminal linked to GND 412B. In cases where the S̅W̅ 406B remains in a HIGH state, M3 410B actively discharges output node 402B to GND 412B, effectively removing any charge present. Similar to the approach used in the modified inverter 400A in FIG. 4A, to ensure the avoidance of potential short-circuit between the power supply rails, PMOS transistor, M4, 408B is integrated to eliminate any direct path between V_{dd} 404B and GND 412B.

An approach using the modified inverter 400A may be preferred based on the intricate challenges posed by the modified inverter 400B, which may demand precise sizing of PMOS and NMOS transistors to attain balanced falling and rising times. The implementation of the modified inverter 400B may be further complicated by the inherently lower mobilities of PMOS transistors compared to NMOS transistors. Given the two PMOS transistors in series in each path of the modified inverter 400B, may result in exceptionally large PMOS transistors. The disadvantages of employing such large PMOS transistors are multifaceted. For example, PMOS transistors may comprise oversized components that occupy significant die area, potentially diminishing the overall design's efficiency and limiting space for other crucial elements. Additionally, the presence of large PMOS transistors may lead to higher parasitic capacitance connected to the output nodes. Parasitic capacitances may significantly impact the performance of cells and CMOS circuits as a whole, as well as affect the access time, power consumption, and noise immunity of cells. An elevated capacitance may necessitate greater power dissipation to discharge output to GND, which may compromise power efficiency. In terms of process variation control, large transistors may not offer a desired level of variation, potentially affecting the reliability and performance of the modified inverter as a PUF. By contrast, the modified inverter 400A may be more advantageous due to several key factors. Additionally, superior electron mobility in NMOS transistors may allow for the use of smaller-sized transistors in series. As such, the modified inverter 400A may yield several significant advantages, such as improved process variation, reduced parasitic capacitance, and more efficient utilization of die area, as compared to the modified inverter 400B.

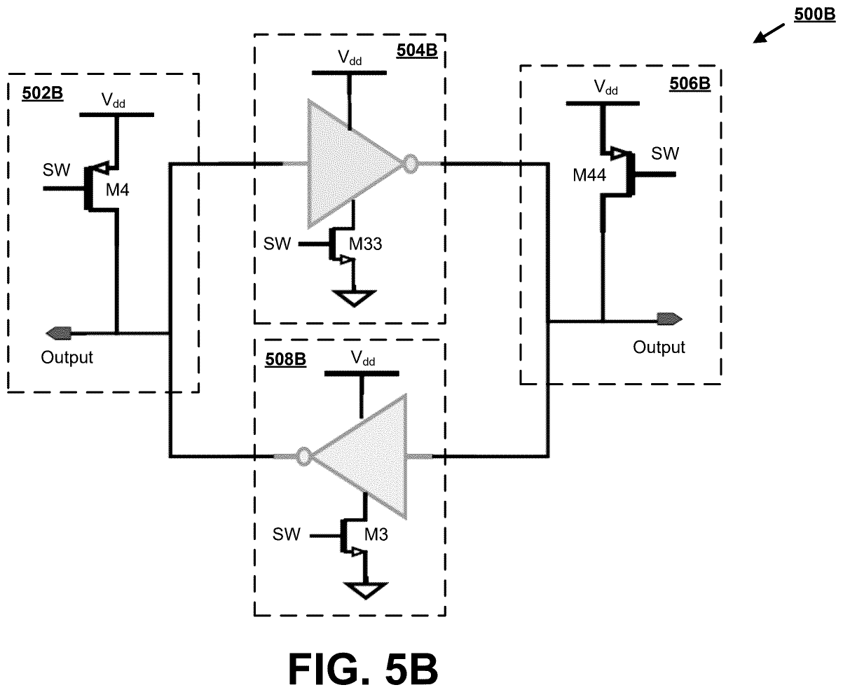

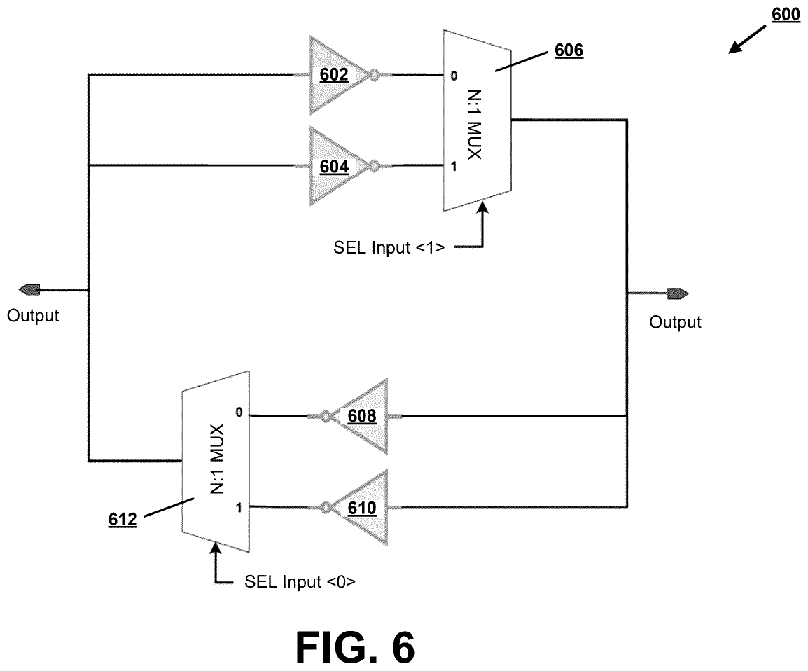

FIG. 5A is a transistor level diagram of a modified SRAM PUF 500A in accordance with some embodiments of the present disclosure. As depicted in FIG. 5A, the modified SRAM PUF 500A comprises two modified inverters 502A and 504A, which are examples of the modified inverter 400A in FIG. 4A that are cross coupled to form a back-to-back inverter.

FIG. 5B is a gate level diagram of a modified SRAM PUF 500B in accordance with some embodiments of the present disclosure. The modified SRAM PUF 500B comprises an addition of four transistors 502B, 504B, 506B, and 508B to a conventional SRAM PUF thereby forming a circuit with enhanced resilience against environmental interference.

### Enhanced Defense Against Attacks: Strong Memory-Based PUF

An SRAM PUF may be characterized as a type of weak PUF that leverages the inherent variations in SRAM cells to generate unique identifiers for authentication and cryptographic applications. Strong PUFs are generally preferred over weak PUFs due to several reasons. For example, strong PUFs may offer enhanced security compared to weak PUFs. The complex and unpredictable responses of strong PUFs make strong PUFs more resistant to various attacks, such as modeling, simulation, and emulation attacks, which are common vulnerabilities for weak PUFs. As another example, strong PUFs may generate highly secure cryptographic keys, making strong PUFs suitable for applications that may demand robust encryption, authentication, and secure communication. Randomness and unpredictability provided by strong PUFs may ensure the integrity and confidentiality of sensitive data. Additionally, strong PUFs may exhibit greater resilience against environmental variations, aging effects, and manufacturing discrepancies, maintaining consistent and reliable performance over time. Such resilience may ensure long-term security and functionality, even in challenging operating conditions. Furthermore, strong PUFs may be deployed in a variety of security-sensitive applications, such as secure bootstrapping, device authentication, secure key generation, and anti-counterfeiting measures, due to their versatility and strong security properties. Additionally, strong PUFs may often meet stringent security standards and compliance requirements mandated by regulatory bodies and industry standards organizations, ensuring adherence to established security guidelines and best practices. Therefore, it may be beneficial to enhance traditional SRAM PUFs to provide a strong PUF in order to attain the aforementioned advantages.

An important difference between weak PUFs and strong PUFs may reside in their challenge-response characteristics. To transform an SRAM PUF from a weak PUF to a strong PUF, the entropy and variability of a SRAM PUF's challenge-response pairs may be increased by enhancing the diversity of challenges presented to the SRAM PUF and augmenting the complexity of the SRAM PUF's response generation mechanism. By increasing the challenge-response space, resistance of the SRAM PUF against modeling attacks may be improved and the SRAM PUF's reliability in adverse operating conditions may be enhanced. As such, strengthening an SRAM PUF may comprise enriching the SRAM PUF's challenge-response behavior to achieve characteristics of a strong PUF.

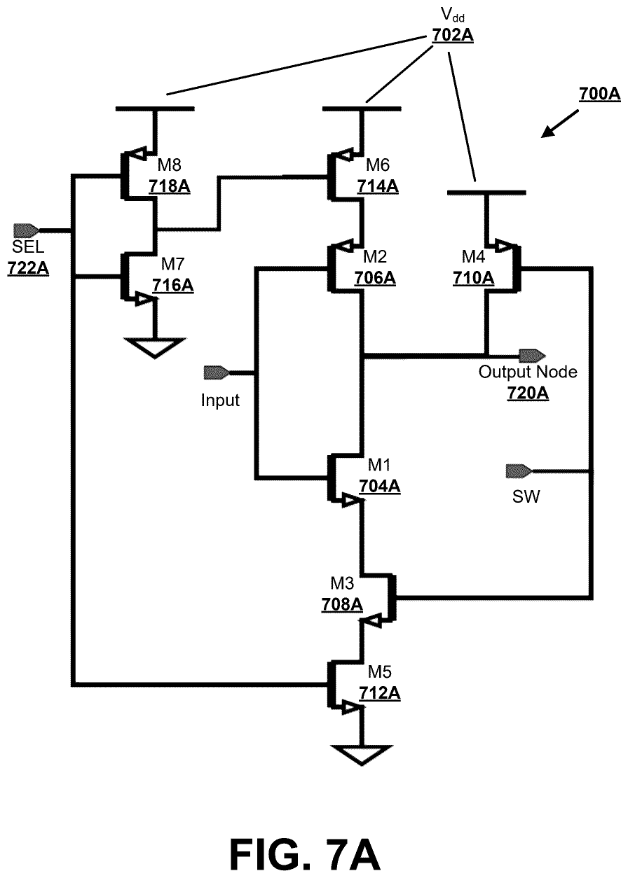

FIG. 6 is a schematic diagram of a strong memory-based PUF 600 in accordance with some embodiments of the present disclosure. To augment the challenge-response space of a traditional SRAM PUF, the strong memory-based PUF 600 comprises a SRAM PUF where each inverter in a traditional SRAM PUF is substituted with multiple parallel inverters. As depicted, a first set of parallel inverters 602 and 604 are interconnected at their inputs and output from each inverter of the first set of parallel inverters 602 and 604 is linked to a respective input of a first N:1 multiplexer (MUX) 606, where N (e.g., 2) may represent the number of parallel inverters on each side of the SRAM PUF. The output of the N:1 MUX 606 is subsequently connected to a common input of a second set of inverters 608 and 610, which comprise outputs that are coupled to respective inputs of a second N:1 MUX 612.

The configuration depicted in FIG. 6 may effectively expand the challenge-response space of a convention SRAM PUF thereby enhancing entropy and strengthening a SRAM PUF's resistance against adversarial attacks. Strong memory-based PUF 600 is depicted as comprising two inverters on each side, however, the number of inverters may range from 2 to N to accommodate different design requirements and optimize performance characteristics according to specific application needs.

Challenges may be applied to the select (SEL) inputs of the N:1 MUXs 606 and/or 612. Depending on the value of the SEL signal, one of the inputs provided by a set of inverters may be selected on N:1 MUX 606 and/or 612, thereby completing an SRAM cell loop. In some embodiments, the length of a challenge may directly depend on the quantity of inverters provided to each N:1 MUX. For example, with N inverters at each N:1 MUX, selecting one of the N inverters may require log₂ N select bits. The challenge length may be calculated by the following formula:

$$Challenge length = 2 \times {log}_{2} N \qquad Equation 1$$

where N is a power of 2 (e.g., 2, 4, 8, 16, etc.) corresponding to the quantity of select lines for such MUXes as determined using binary encoding. For example, if N=2, a MUX may comprise log₂ 2=1 bit for selecting one specific inverter from input, and a total of two bits for an entire PUF. Hence, to augment the number of challenges, as per Equation 1, the quantity of inverters on each side may be varied (e.g., increased). The count of challenge-response pairs that the strong memory-based PUF 600 provides may be determined based on the following equation:

$$Number of Challenges = {2}^{( 2 \times {log}_{2} N )} \qquad Equation 2$$

Based on Equation 2, the number of challenges that strong memory-based PUF 600 may provide is four. In the depicted configuration, an input SEL<1:0> may provide a delineator that delineates four distinct challenge-responses for the strong memory-based PUF 600.

For SEL<1:0> comprising a binary value of 00, inverter 602 is selected from the top branch and inverter 608 is selected from the bottom branch. During the power-up state, inverters 602 and 608 synergize to generate a PUF response that corresponds to an input challenge SEL<1:0>=00.

Subsequently, in a scenario where SEL<1:0> comprises a binary value of 01, inverter 602 is selected from the top branch and inverter 610 is selected from the bottom branch. Within the power-up state, inverters 602 and 610 collaboratively generate a PUF response that corresponds to an input challenge SEL<1:0>=01.

When SEL<1:0> comprises a binary value of 10, inverter 604 is selected from the top branch and inverter 608 is selected from the bottom branch. During the power-up state, inverters 604 and 608 may work in tandem to generate a PUF response that corresponds to an input challenge SEL<1:0>=10.

In a scenario where SEL<1:0> comprises a binary value of 11, inverter 604 is selected from the top branch and inverter 610 is selected from the bottom branch. During the power-up state, inverters 604 and 610 may generate a PUF response that corresponds to an input challenge SEL<1:0>=11.

Within each configuration, the selection of different inverters may introduce process variation in the form of nuanced differences among the inverters based on their specific locations on the die thereby resulting in distinct power-up states for each case, as the inherent variability in the fabrication process influences the behavior of individual inverters. Accordingly, meticulous configuration of select lines and corresponding inverters may ensure the precision and reliability of strong memory-based PUF's responses across various input challenges, underscoring robustness and effectiveness of the disclosed strong memory-based PUF in cryptographic applications.

### MBM-PUF Implementation in ASIC

As disclosed herewith, a traditional SRAM PUF may be modified to address distinct challenges in PUF technology. A first modification, e.g., comprising modified inverters, may bolster the resilience of a traditional SRAM PUF structure against environmental noises and fluctuations. A second modification, e.g., comprising parallel inverters coupled to N:1 MUXes, may transform a weak SRAM PUF into a strong memory-based PUF to provide increased efficacy against a spectrum of attacks. To achieve a secure and robust PUF implementation on an application-specific integrated circuit (ASIC), both modifications may be applied while making necessary adjustments to facilitate easier implementation. By combining enhancements aimed at fortifying the PUF structure against environmental noise and fluctuations with techniques that strengthen SRAM PUFs, a comprehensive framework may be provided that ensures both resilience and reliability.

In some embodiments, the second modification may be further refined with respect to MUX design. While the N:1 MUXs 606 and 612 used in strong memory-based PUF 600 serve well for connecting the outputs of two inverters with minimal area overhead, scaling up the number of inverters (e.g., to 4, 8, 16, etc.) may require adequately designed MUXes thereby introducing added complexity. The added complexity may consume excessive die area and exacerbate power consumption, diminishing overall design efficiency. Furthermore, the use of MUX imposes limitations on the number of additional inverters that can be incorporated on each side, i.c., restricted to powers of 2. For instance, if a requirement calls for five inverters on each MUX, alternative implementation methods may be called for to circumvent this constraint effectively.

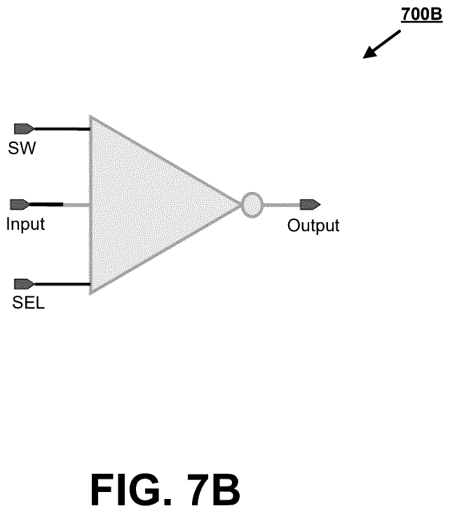

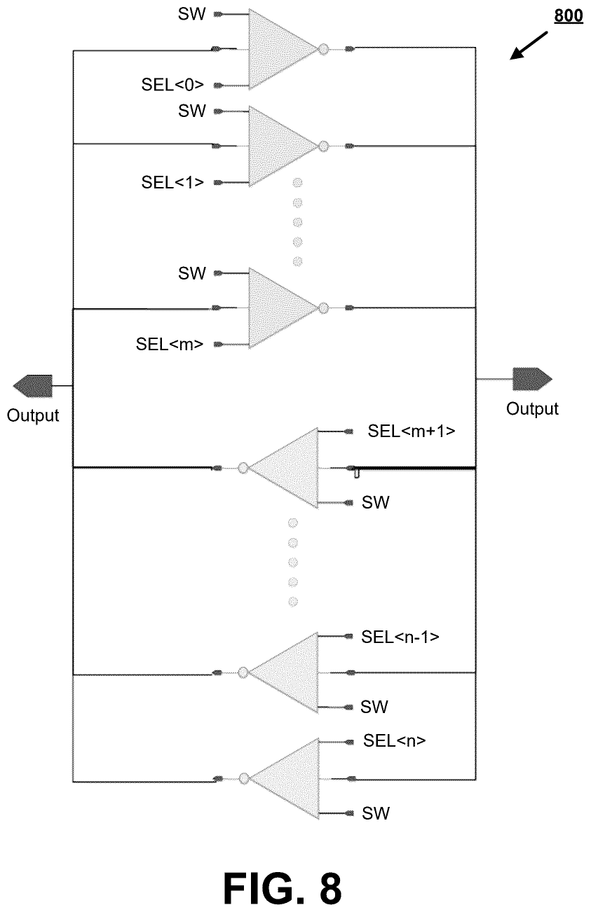

FIG. 7A is a transistor level diagram of a modified inverter 700A in accordance with some embodiments of the present disclosure. The modified inverter 700A comprises a modification that integrates multiplexing functionality into the modified inverter 400A in FIG. 4A for flexible selection based on input signal SEL. The modified inverter 700A may accommodate any number of inverters on each side without confinement to powers of 2 and/or without adding to design and/or routing complexity. By activating the signal SEL, a designated inverter becomes selected, while the other inverters on the same side as the designated inverter become unselected. Such a mechanism may ensure precise control over the selection process and facilitate flexibility for accommodating varying numbers of inverters without being constrained by powers of 2.

As depicted in FIG. 7A, transistors M1 704A and M2 706A may comprise core inverters components, while transistors M3 708A and M4 710A may be utilized for pulling the output node 720A to V_{dd} 702A. Transistors M5 712A and M6 714A may be dedicated to multiplexing (MUXing) functions. A source terminal of the transistor M5 712A is coupled to a drain terminal of the transistor M3 708A and a drain terminal of the transistor M6 714A is coupled to a source terminal of the transistor M2 706A. Additionally, transistors M7 716A and M8 718A may be employed for converting the SEL signal 722A to its complementary form and provide the complementary SEL signal to transistor M6 714A, which may enable precise control over the selection process within the modified inverter 700A. A gate terminal of transistor M6 714A is coupled to a drain terminal of the transistor M7 716A and a drain terminal of the transistor M8 718A. The SEL signal 722A is coupled to the gate terminals of transistors M5 712A, M7 716A, and M8 718A. In some embodiments, when the SEL signal 722A is in a HIGH state, the modified inverter 700A becomes enabled. When the SEL signal 722A is in a LOW state, the modified inverter 700A becomes disabled. A modified inverter 700B depicted in FIG. 7B is a gate level diagram of the modified inverter 700A.

A PUF that comprises the modified inverter 700A may provide an advantage of enabling the use of any number of inverters for a strong PUF while eliminating issues such as complexity, added area overhead, and unsymmetrical structures caused by the presence of N:1 MUX. The benefits of modified inverter 700A may become particularly significant as the number of inverters on each MUX side of a desired strong PUF increases beyond 2.

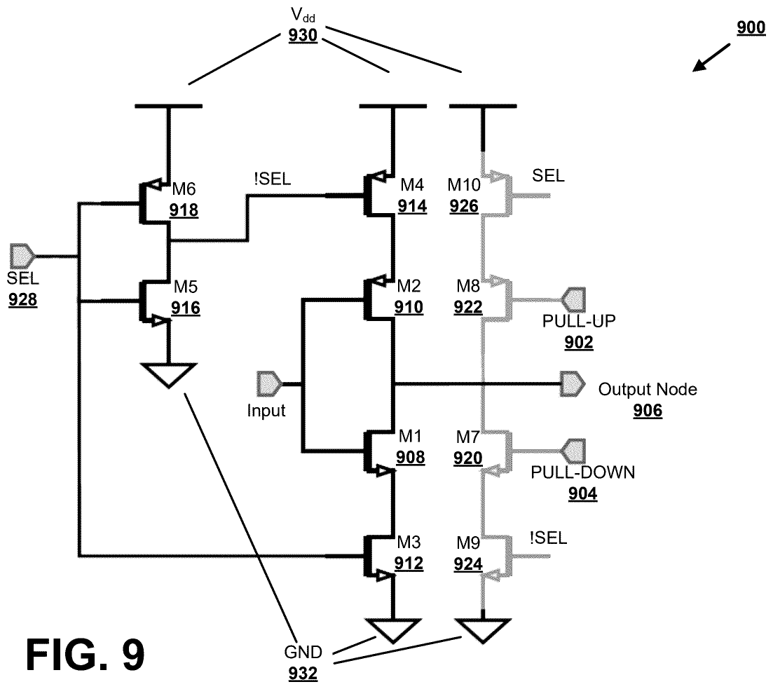

FIG. 8 is a gate level diagram of an example strong memory-based PUF 800 in accordance with some embodiments of the present disclosure. As depicted in FIG. 8, the strong memory-based PUF 800 comprises an implementation that is based on the modified inverter 700B (or modified inverter 700A). The strong memory-based PUF 800 integrates a MUXing mechanism within each inverter, offering the flexibility to utilize any number of inverters on each side.

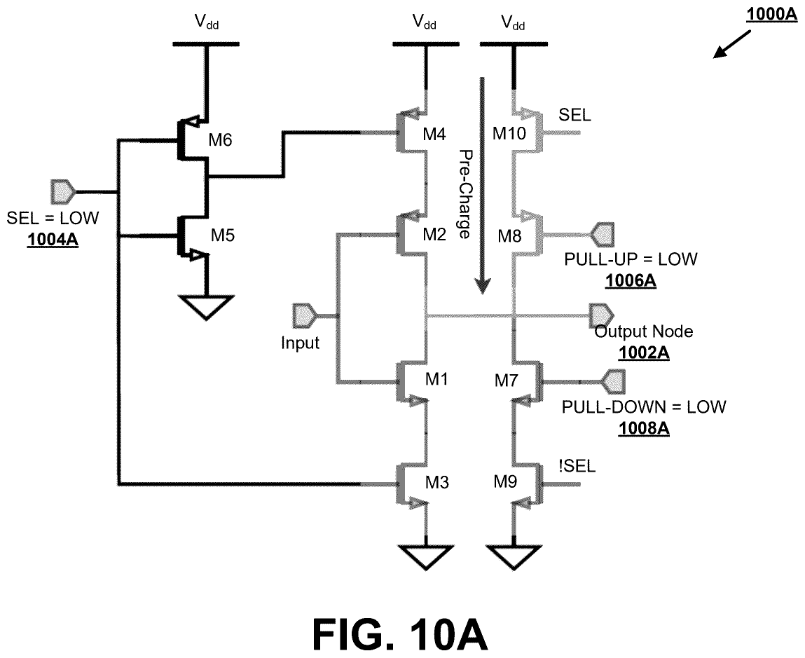

FIG. 9 is a transistor level diagram of a modified inverter 900 in accordance with some embodiments of the present disclosure. Similar to the modified inverter 700A/700B, FIG. 9 depicts a modified inverter 900 that comprises 10 transistors (M1 through M10), however, with additional functionality of being able to both pull up (902) and pull down (904) at the output node 906. The additional functionality may double the source of entropy by generating different signatures for the same challenge, which may be provided by pre-charging the output node 906 of the modified inverter 900 during a PUF signature extraction operation and then pre-draining the output node 906 along with extracting the PUF signature. Due to process variations, the properties of the transistors (M1 through M10) in the modified inverter 900 may vary between devices, resulting in PUF signatures with a high degree of uniqueness.

The modified inverter 900 comprises an inverter activation system and a primitive pre-conditioning system. The inverter activation system comprises transistors M3 912, M4 914, M5 916 and M6 918. When the SEL 928 line is LOW, the transistors M3 912 and M4 914 are switched off. This in turn isolates a first inverter element (transistors M1 908 and M2 910) from the supply voltage V_{dd} 930 and ground GND 932. Conversely, when SEL 928 is HIGH, the first inverter clement is connected to the supply voltage V_{dd} 930 and ground GND 932.

The pre-conditioning system comprises transistors M7 920, M8 922, M9 924, and M10 926. When SEL 928 is HIGH, the inverter system and the pre-conditioning system become active and inactive respectively, and conversely, when SEL 928 is LOW, the inverter system becomes inactive, but the pre-conditioning system becomes activated. With the pre-conditioning system activated, when the PULL-UP pin 902 is held LOW, the output node 906 is forced to the supply voltage V_{dd} 930 and conversely when the PULL-UP pin 902 is held HIGH, the output node 906 is isolated from the supply voltage V_{dd} 930. Similarly, PULL-DOWN pin 904 is able to force the output node 906 to GND 932 or isolate the output node 906 from the GND 932. Accordingly, the output node 906 may be isolated from either supply voltage V_{dd} 930 or GND 932 when the transistors M7 920 and M8 922 are held at LOW and HIGH, respectively.

In some embodiments, an external controller may be configured to select and deselect instances of the modified inverter 900. The external controller may also be responsible for controlling the pre-conditioning system. When the modified inverter 900 is in pre-conditioning phase, the external controller may ensure that the first inverter clement is isolated from both supply voltage V_{dd} 930 and ground GND 932 by holding the SEL 928 at LOW. The external controller may also drive the pre-conditioning system to cither pre-charge (PULL-UP=LOW 902 and PULL-DOWN=LOW 904) or pre-drain (PULL-UP=HIGH 902 and PULL-DOWN =HIGH 904) at a single instance of time but never activate both pre-charge and pre-drain (PULL-UP=LOW 902 and PULL-DOWN=HIGH 904), which may cause a short-circuit with a direct path from the supply voltage V_{dd} 930 and ground GND 932 and thereby causing damage to the modified inverter 900. When the modified inverter 900 enters the post-conditioning phase, the external controller may hold the SEL 928 line to HIGH, thus activating the first inverter element. Simultaneously, it may also deactivate the pre-conditioning system (PULL-UP=HIGH 902 and PULL-DOWN=LOW 904).

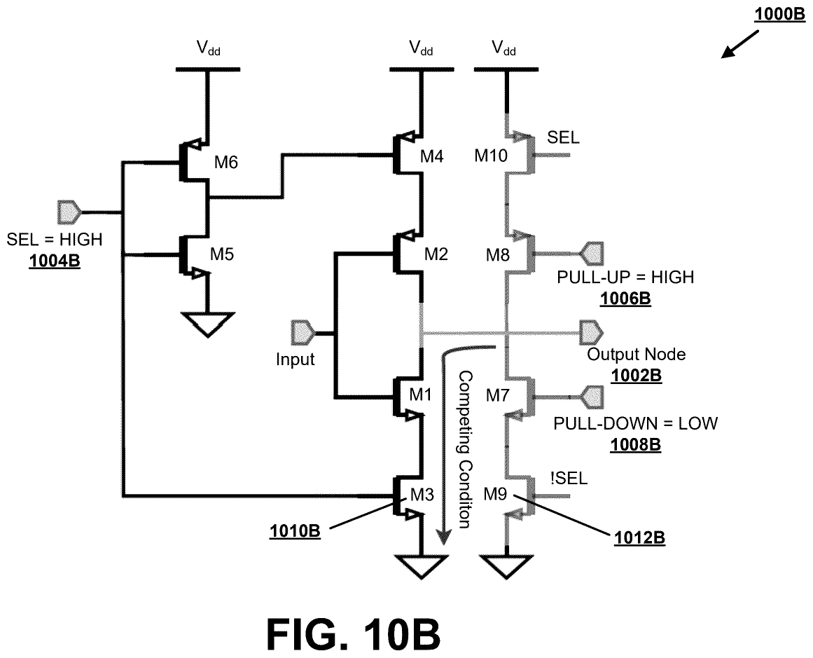

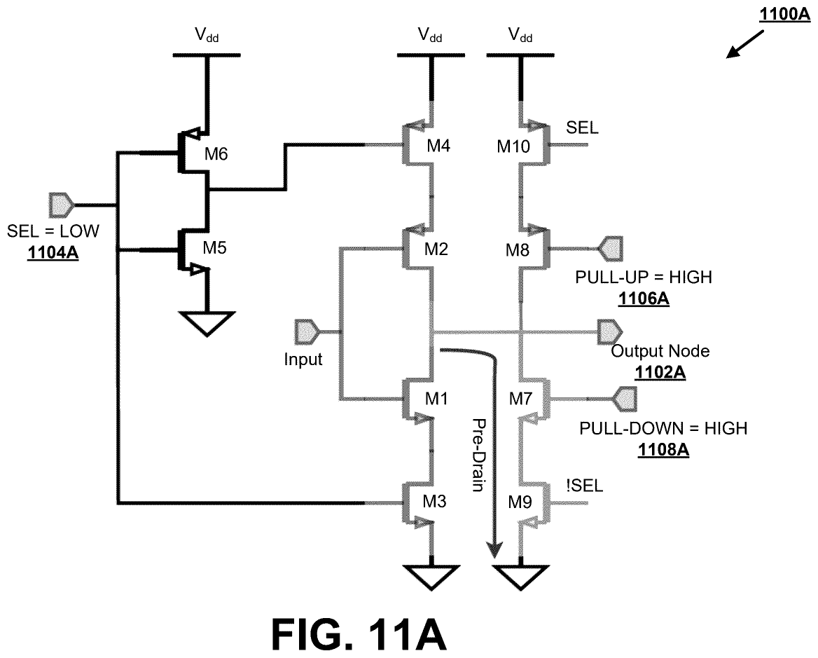

FIG. 10A is a transistor level diagram of a modified inverter 1000A that is configured for pre-charging during a pre-conditioning phase in accordance with some embodiments of the present disclosure. The modified inverter 1000A is an example of the modified inverter 900. A PUF signature may be extracted when a pre-conditioning system conditions the output node 1002A of the modified inverter 1000A. The output node 1002A of the modified inverter 1000A may be conditioned by an external controller that switches off the first inverter element corresponding to transistor M3 1010B (SEL=LOW 1004A), and also by triggering pre-charging of the output node 1002A by triggering both PULL-UP 1006A and PULL-DOWN 1008A to LOW.

FIG. 10B is a transistor level diagram of a modified inverter 1000B that is configured for pre-charging during a post-conditioning phase in accordance with some embodiments of the present disclosure. The modified inverter 1000B is an example of the modified inverter 900. After conditioning the output node 1002B of the modified inverter 1000B, an external controller may change the phase from pre-conditioning to post-conditioning by triggering SEL 1004B to HIGH and at the same time deactivating the pre-conditioning system (PULL-UP=HIGH 1006B and PULL-DOWN=LOW 1008B). During the post-conditioning phase, both inverters corresponding to transistors M3 1010B and M9 1012B may compete against each other draining their respective output terminals. That is, a competition happens between the M3 1010B and M9 1012B NMOS transistors, where a corresponding inverter of one of M3 1010B or M9 1012B transistors that is able to drain its output port faster attains LOW and the other inverter is forced to HIGH.

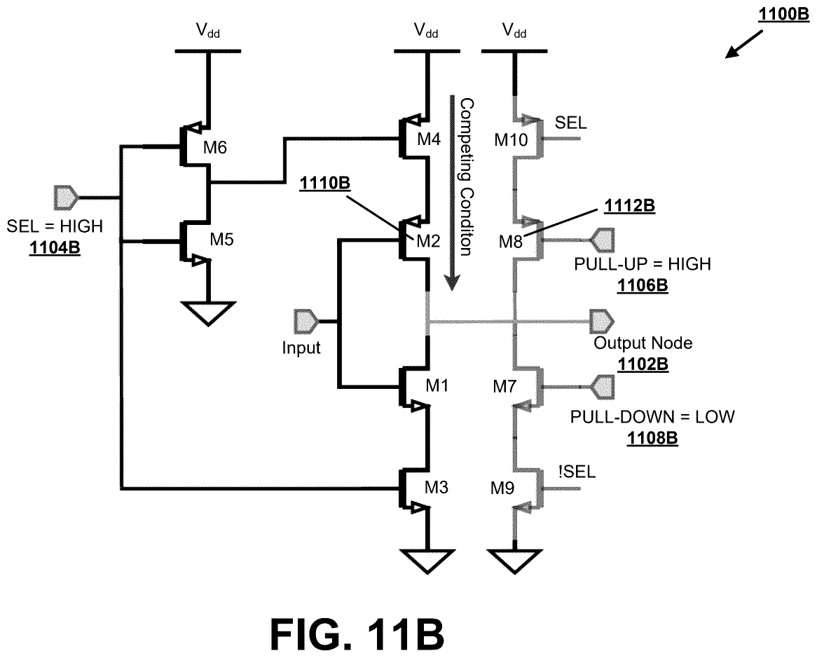

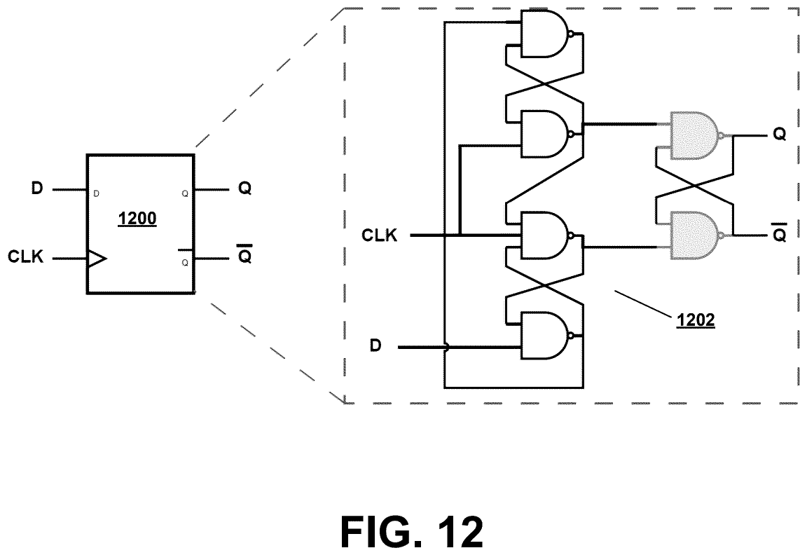

FIG. 11A is a transistor level diagram of a modified inverter 1100A that is configured for pre-draining during a pre-conditioning phase in accordance with some embodiments of the present disclosure. The modified inverter 1100A is an example of the modified inverter 900. A PUF signature may be extracted when the pre-conditioning system conditions the output node 1102A of the modified inverter 1100A. The external controller again switches off the first inverter clement (SEL=LOW) and triggers pre-draining the output node 1102A by triggering both PULL-UP 1106A and PULL-DOWN 1108A to HIGH.

FIG. 11B is a transistor level diagram of a modified inverter 1100B that is configured for pre-draining during a post-conditioning phase in accordance with some embodiments of the present disclosure. The modified inverter 1100B is an example of the modified inverter 900. After pre-draining the output node 1102B of the modified inverter 1100B, the external controller may change the phase from pre-conditioning to post-conditioning by triggering SEL 1104B to HIGH and at the same time deactivating the pre-conditioning system (PULL-UP=HIGH 1106B and PULL-DOWN=LOW 1108B). During the post-conditioning phase, both inverters corresponding to transistors M2 1110B and M8 1112B may compete against each other charging their respective output terminals. That is, a competition happens between the transistors M2 1110B and M8 1112B PMOS transistors. A corresponding inverter of one of M2 1110B or M8 1112B that is able to charge its output port faster attains HIGH and the other inverter is forced to LOW.

According to various embodiments of the present disclosure, an MBM-PUF provides a flexible approach to security implementation by leveraging back-to-back inverters as building blocks.

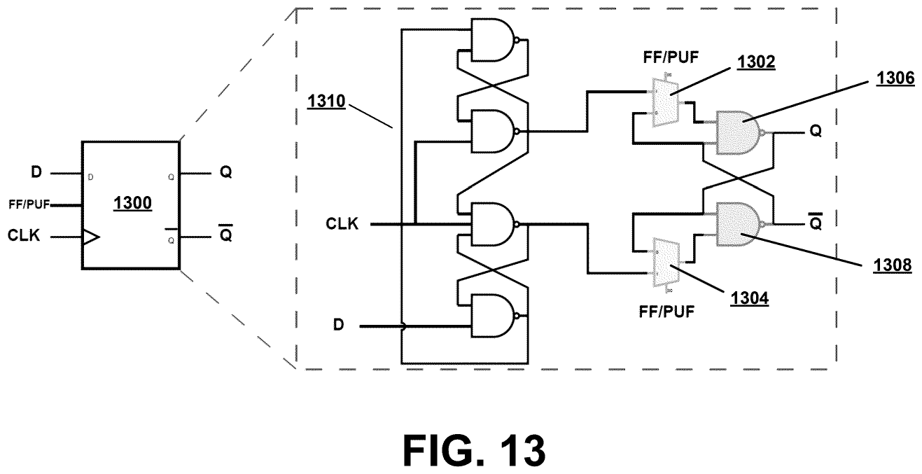

FIG. 12 is a component diagram of an example edge-triggered D flip-flop 1200 with a NAND gate implementation. As disclosed herewith, resources within the edge-triggered D flip-flop 1200 may be repurposed for the implementation of both weak and strong SRAM PUFs. For example, cross-coupled NAND gates 1202 may be repurposed as back-to-back inverters in a manner as depicted in FIG. 1A. Inputs of a first set of NAND gate are connected to each other and coupled with outputs of a second set of NAND gate, and vice versa, a combination of the first and second sets of NAND gates may function as a back-to-back inverter. Thus, leveraging such behavior of NAND gates may facilitate the implementation of two back-to-back inverters within an edge-triggered D flip-flop.

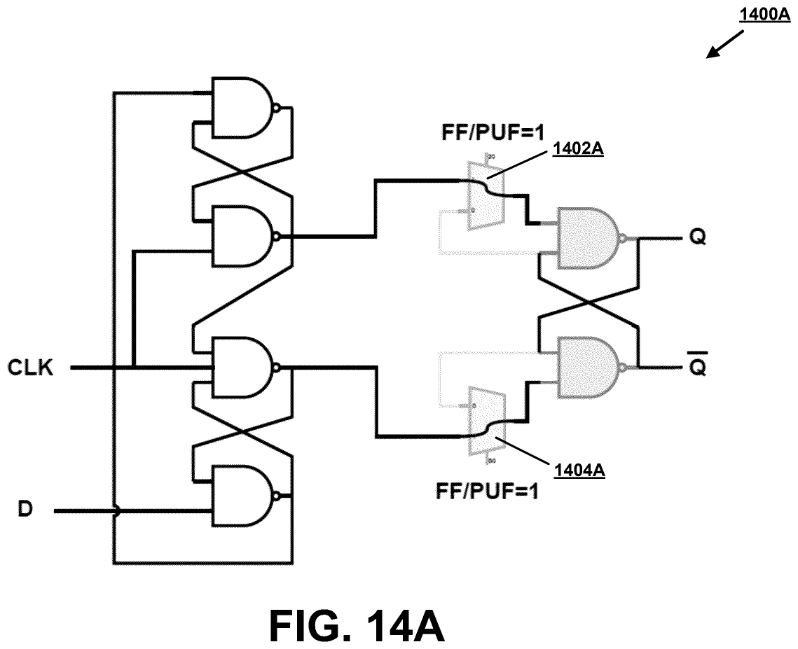

FIG. 13 is a component diagram of an example modified edge-triggered D flip-flop circuit 1300 in accordance with some embodiments of the present disclosure. The modified edge-triggered D flip-flop circuit 1300 comprises 2:1 MUXes 1302 and 1304 that are configured in between cross-coupled NAND gates 1310 and D-latch NAND gates 1306 and 1308. A 2:1 MUX 1302/1304 comprises (i) an output that is coupled to a first input of a first D-latch NAND gate 1306/1308 (ii) a first input that is coupled to an output from the cross-coupled NAND gates 1310, and (iii) a second input that is coupled to (a) a second input of the first D-latch NAND gate 1306/1308 and (b) an output of a second D-latch NAND gate 1306/1308. Each of the two 2:1 MUXes 1302 and 1304 are provided with a control signal, FF/PUF, to configure operation of the modified edge-triggered D flip-flop circuit 1300.

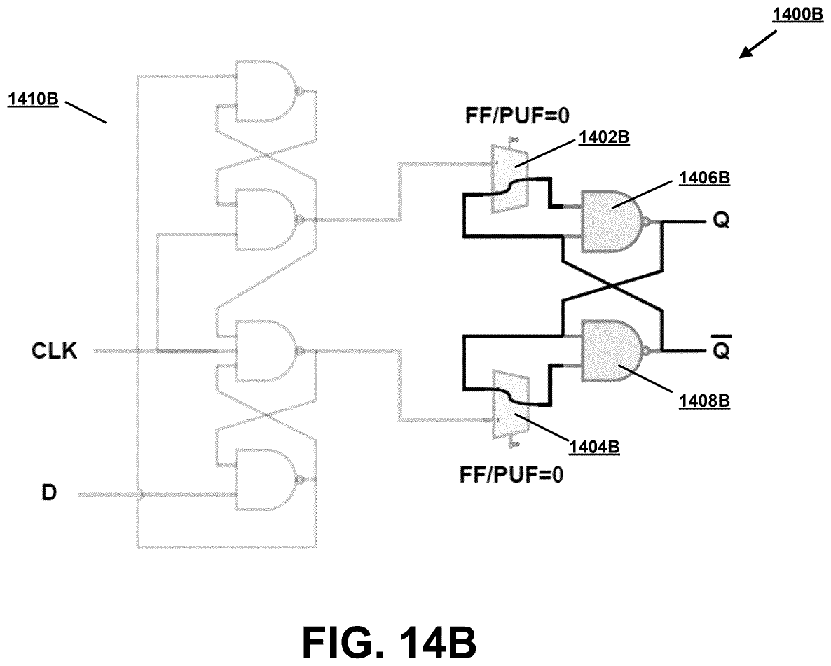

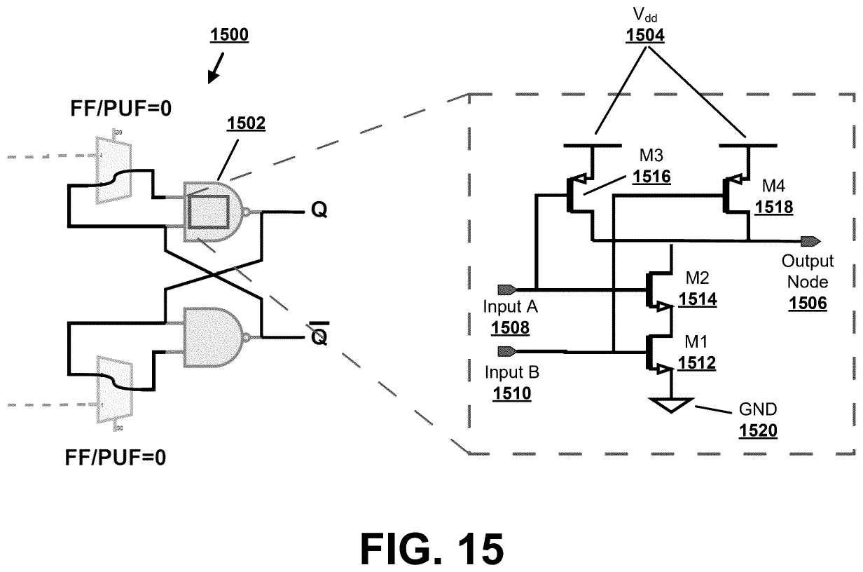

FIG. 14A is a gate level diagram of an example flip-flop circuit 1400A operating in an edge-triggered D flip-flop mode in accordance with some embodiments of the present disclosure. The flip-flop circuit 1400A is an example of the modified edge-triggered D flip-flop circuit 1300 in FIG. 13. The flip-flop circuit 1400A comprises two MUXes 1402A and 1404A, each of which may be configured with a control signal FF/PUF that is set to ‘1,’ which corresponds to normal operation (e.g., edge-triggered D flip-flop mode) of the flip-flop circuit 1400A.

FIG. 14B is a gate level diagram of an example flip-flop circuit 1400B operating in a PUF mode in accordance with some embodiments of the present disclosure. The flip-flop circuit 1400B is an example of the modified edge-triggered D flip-flop circuit 1300 in FIG. 13. The flip-flop circuit 1400B comprises two MUXes 1402B and 1404B, each of which may be configured with a control signal FF/PUF that is set to ‘0,’ which corresponds to a PUF mode. When FF/PUF is set to 0, the inputs of the NAND gates 1406B and 1408B become connected to each other, effectively disconnecting the two NAND gates 1406B and 1408B from a portion 1410B of the flip-flop circuit 1400B. As such, the configuration of the MUXes 1302 and 1304 in modified edge-triggered D flip-flop circuit 1300 as disclosed with reference to MUXes 1402A and 1404A in flip-flop circuit 1400A and MUXes 1402B and 1404B in flip-flop circuit 1400B, enables NAND gates to function as inverters thereby converting from operation as an edge-triggered D flip-flop into a PUF. Thus, by repurposing the resources inherent within a flip-flop, a final design may achieve low cost and area efficiency. However, as disclosed above, the modified edge-triggered D flip-flop circuit 1300 may be characterized as a flip-flop with a built-in weak PUF.

In some embodiments, weak PUFs integrated within edge-triggered D flip-flops are enhanced by increasing the number of challenge-response domains. To do so, NAND gates of modified edge-triggered D flip-flop circuit 1300 may be modified. To enhance the resilience of the weak PUF within the modified edge-triggered D flip-flop circuit 1300 and transform the weak PUF into a strong PUF, the NAND gates may be substituted with modified NAND gates. In some embodiments, the modified NAND gates may incorporate additional inputs such as SW and SEL to fortify PUF responses against environmental noise and bolster resistance against potential attacks. By integrating enhanced features into the NAND gates, the resulting strong PUF may exhibit greater robustness and security, ensuring its reliability even in challenging operational environments and against malicious threats.

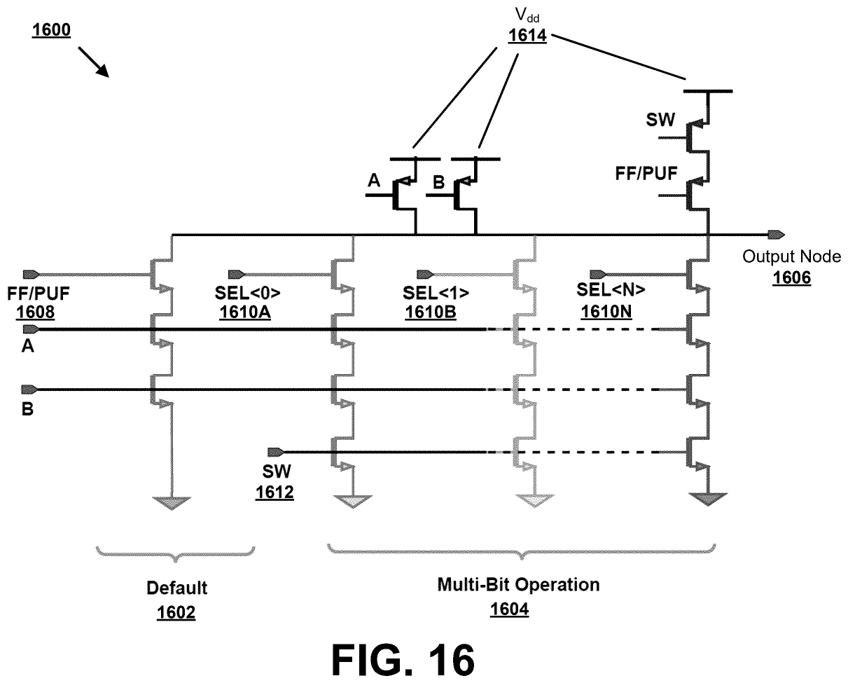

FIG. 15 is a component diagram of an example NAND gate 1500 in accordance with some embodiments of the present disclosure. A 2-input NAND gate 1502 is implemented using a combination of PMOS and NMOS transistors. The NAND gate 1502 comprises a pair of PMOS transistors M3 1516 and M4 1518 that are connected in parallel and a pair of NMOS transistors M1 1512 and M2 1514 that are connected in series. The PMOS transistors M3 1516 and M4 1518 are linked in parallel between the output node 1506 and the supply voltage V_{dd} 1504, and their gates are coupled respectively to one of the NAND gate inputs A 1508 or B 1510. Conversely, the NMOS transistors M1 1512 and M2 1514 are arranged in series between the output node 1506 and the GND 1520, with their gates are coupled respectively to one of the NAND gate inputs A 1508 or B 1510.

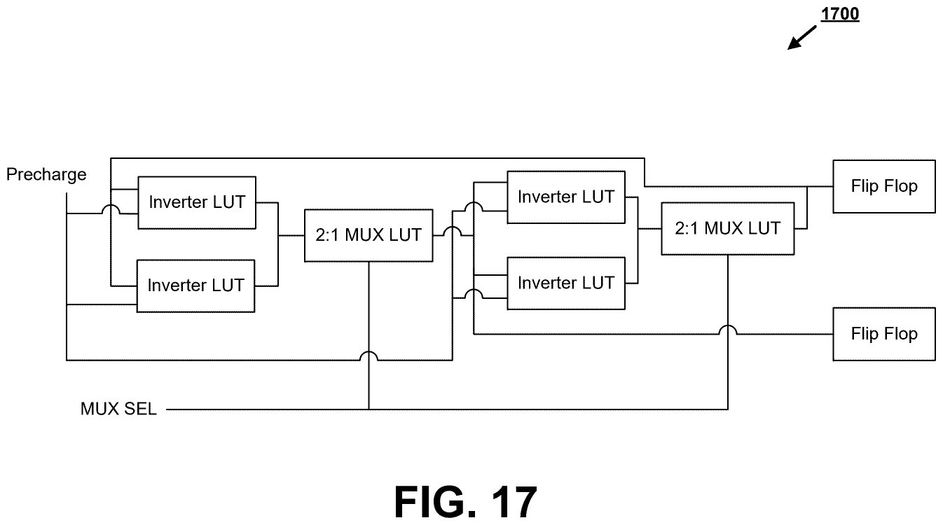

FIG. 16 is a transistor level diagram of an example modified NAND gate 1600 in accordance with some embodiments of the present disclosure. The modified NAND gate 1600 comprises a plurality of NAND structures that are arranged in parallel branches that are coupled to respective control signals. In some embodiments, operation of the modified NAND gate 1600 comprises one of the plurality of NAND structures that is activated based on a control signal. In some embodiments, the modified NAND gate 1600 is configured to operate in a flip-flop mode of operation where a first NMOS pull-down branch (default 1602) is linked to an output node 1606 of the modified NAND gate 1600 by applying a FF/PUF signal 1608 that is in a HIGH state, while the other pull-down branches (multi-bit operation 1604) remain inactive. As such, a default NAND structure may govern the output node 1606 behavior of the modified NAND gate 1600 when configured in an edge-triggered D flip-flop.

In some embodiments, the modified NAND gate 1600 is configured to function as part of a strong PUF structure. In some embodiments, during strong PUF operation, the default NAND structure is disconnected from the output node 1606 via an FF/PUF signal 1608 that is in a low state (e.g., PUF mode of operation). The strong PUF operation may further comprise selectively connecting one of the multi-bit operation branches to the output node 1606 of the modified NAND gate 1600 based on the value of SEL<N:0> (e.g., SEL<0> 1610A, SEL<1> 1610B, and SEL<N> 1610N). The strong PUF operation of the modified NAND gate 1600 may ensure that a selected pull-down branch based on the SEL<N:0> signal contributes to the output node 1606 response, thereby enhancing the robustness and security of the strong PUF against various environmental factors and potential attacks.

A mitigation of environmental noise affecting operation of the modified NAND gate 1600 may be achieved by employing a SW signal 1612 to pull the output node 1606 to V_{dd} 1614. By doing so, the influence of environmental disturbances on the PUF responses may be effectively eliminated. However, the environmental noise elimination functionality may be disabled when the FF/PUF signal 1608 is in a HIGH state (e.g., flip-flop mode of operation) which may ensure that the modified NAND gate 1600 operates correctly during flip-flop operation without interference from the environmental noise elimination mechanism. By the aforementioned features, the modified NAND gate 1600 maintains the integrity and performance of a flip-flop while enhancing the robustness of a PUF against external factors.

Accordingly, the NAND gates in the output stage of modified edge-triggered D flip-flop circuit 1300 may comprise two of the modified NAND gate 1600, each dependent on a SEL signal (e.g., SEL<0> 1610A, SEL<1> 1610B, and SEL<N> 1610N), which may serve as the challenge to the PUF. One structure from a first modified NAND gate and one structure from a second modified NAND gate may be selected based on the SEL signal. Given that the inputs of the two modified NAND gates are interconnected, they may effectively function as inverters. This arrangement enables the implementation of an MBM-PUF inside an edge-triggered D flip-flop. With the MBM-PUF configuration, a flip-flop can effectively leverage PUF properties for cryptographic applications, thereby enhancing security and reliability.

### MBM-PUF Implementation in FPGA

Field-programmable gate arrays (FPGAs) may comprise highly versatile digital circuits that are capable of being reprogrammed to execute a wide array of tasks from simple logic operations to complex computational functions. A FPGA may comprise an array of programmable logic blocks/slices, interconnects, and I/O pads. The logic blocks or slices may be configured to perform complex combinational and sequential logic functions. For example, an FPGA board may comprise a unique architecture of slices, programable interconnects, specialized memory units, etc. A slice on a FPGA board may comprise a plurality of lookup tables (LUTs) and flip-flops, which may comprise primary components for logic operations and storage, respectively. The configuration provided by FPGAs allows for a high degree of flexibility and capability within the FPGA fabric.

LUTs may comprise a building block component of FPGA slices and serve as configurable logic blocks that are capable of implementing any Boolean function. A LUT may operate by storing truth tables of a Boolean function it is configured to perform. As such, by configuring a LUT's memory, the LUT may perform any specific logic operation. On a given FPGA board, each LUT may easily handle inputs up to 6 bits, allowing the LUT to store and execute complex functions. Flip-flops in FPGA fabric may be used for storing binary data (1 bit per flip-flop) and may be essential for creating sequential logic circuits as flip-flops may provide a memory element required for stateful operations. Flip-flops may often be integrated into slices alongside LUTs to facilitate the creation of complex timing-based circuits. For example, a combination of LUTs and flip-flops within each slice of a FPGA board may allow for the implementation of both combinational and sequential circuits. The flexibility offered by the FPGA fabric makes it suitable for a broad range of applications including the implementation of an MBM-PUF.

In FPGA architectures, interconnects may also play a critical role as they facilitate the routing of signals between different logic blocks, I/O blocks, and other components within a chip. Interconnects may comprise a network of wiring segments and programmable switches. An interconnect system may enable an FPGA to be a fully programmable and flexible device, allowing for the customization of a logic circuit layout according to specific design requirements. Interconnect components may be dynamically configured to create paths for signal transmission between different functional elements of a FPGA. The complexity and efficiency of an interconnect architecture may greatly influence the performance, power consumption, and overall effectiveness of an FPGA. Wiring segments in FPGA interconnects may vary in length and may be strategically distributed across the FPGA fabric. For example, interconnects may be short for connecting nearby elements or span longer distances to connect distant parts of a chip, facilitating broader data pathways that may be essential for complex data processing tasks. As disclosed herewith, interconnects may affect the signature quality of an MBM-PUF.

Programmable switches or routing matrices may provide adaptability of a FPGA. For example, switches may open or close different routing paths, allowing the FPGA's circuit configuration to be altered as needed. Flexibility provided by switches may be crucial for optimizing an FPGA's layout for specific applications, which may potentially enhance performance by reducing delays and improving signal integrity.

According to various embodiments of the present disclosure, an MBM-PUF with a structure that is based on strong memory-based PUF 800 may be configured in FPGA.

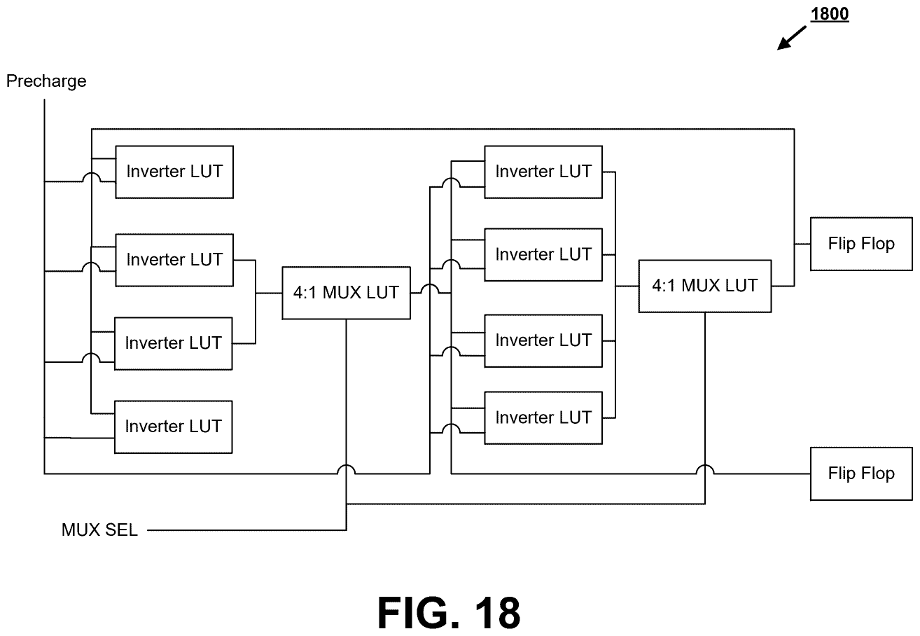

FIG. 17 is a schematic of an example FPGA platform 1700 in accordance with some embodiments of the present disclosure. The FPGA platform 1700 comprises a 2×2 MBM-PUF configuration with two inverters on each branch. As depicted in FIG. 17, the FPGA platform 1700 comprises six LUTs and two flip-flops.

FIG. 18 is a schematic of an example FPGA platform 1800 in accordance with some embodiments of the present disclosure. The FPGA platform 1800 comprises a 4×4 MBM-PUF configuration with four inverters on each branch. As depicted in FIG. 18, the FPGA platform 1800 comprises 10 LUTs and two flip-flops.

As disclosed herewith, a modified inverter cell may be used in an MBM-PUF to ensure the stability and quality of a PUF signature. In some embodiments, a modified inverter primitive is generated by writing a register transfer language (RTL) code that incorporates the functionality of pre-charge where the output ports are pulled to high when the pre-charge port is held to high and otherwise inverts the signal available at the input port. In some embodiments, a modified inverter primitive is generated by directly instantiating a 2-bit LUT (LUT2) and programming it with an adequate bitstream. It may be noted that directly tapping into one of the output ports to record a PUF signature can disbalance an MBM-PUF structure by adding additional parasitic capacitance to the tapped output port. To mitigate this issue, a buffer may be added at each of the output nodes such that adding a connection at the output ports for recording a PUF signature does not disrupt the modified inverter primitives.

To map an MBM-PUF to a FPGA fabric, a design of the MBM-PUF may be broken down into atomic units, such as modified inverters, multiplexers, and buffers. The atomic units may be mapped to LUTS which are used for emulating combinational logic. Buffers may be mapped to flip-flops in a FPGA slice.

A design may be automatically (e.g., unsupervised) mapped to an FPGA fabric by using an electronic design automation (EDA) tool. EDA tools, such as Vivado, may follow its own algorithm to efficiently map resources to LUTS to reduce routing and minimize the number of resources used. While handy for generic applications, mapping an MBM-PUF structure via EDA tools may degrade PUF quality significantly because EDA tools may not take into account that modified inverter primitives of the MBM-PUF structure may require balancing. For example, placement of LUTs in a FPGA fabric may be supervised such that inverters and multiplexers are placed in a balanced manner. In some embodiments, balancing modified inverter primitives may be supervised by using design constraints files, where each modified inverter primitive may be exactly mapped to a LUT located on a FPGA fabric. An ideal placement may be considered to place all inverters of a single branch and its associated multiplexer in one single slice (e.g., the first half of an MBM-PUF primitive) and the second half of the MBM-PUF primitive on a second slice. It may be noted that increasing the number of inverters on a single branch may lead to using more than one slice to accommodate the inverters which may lead to adding more routing in a complete MBM-PUF primitive and gradually increases parasitic capacitance. Increased parasitic capacitance may disrupt balance and lead to degradation of quality of a resulting PUF signature.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. An apparatus comprising:
a pair of inverters that are configured in a cross-coupled configuration, wherein an inverter of the pair of inverters comprises a static random-access memory (SRAM) physically unclonable function (PUF) circuit, wherein the SRAM PUF circuit comprises:
an inverter; and
an inverter cell comprising a p-channel metal-oxide-semiconductor (PMOS) transistor, an n-channel metal-oxide-semiconductor (NMOS) transistor, and output node, and a control signal input, wherein:
(i) the PMOS transistor comprises (a) a drain terminal that is coupled to an output and (b) a source terminal that is coupled to a supply voltage,
(ii) the NMOS transistor comprises a gate terminal that is coupled to a gate of the PMOS transistor that inhibits a path between the supply voltage and ground, and
(iii) responsive to a low state provided to the control signal input, the control signal input causes the PMOS transistor to charge the output node to the supply voltage.

2. An apparatus comprising:
a pair of multiplexers, wherein (i) a first multiplexer of the pair of multiplexers comprises a first set of multiplexer inputs, a first multiplexer output, and a first select input and (ii) a second multiplexer of the pair of multiplexers comprises a second set of multiplexer inputs, a second multiplexer output, and a second select input;
a first set of inverters comprising (i) a first set of inverter inputs that is coupled to the second multiplexer output and (ii) a first set of inverter outputs that is coupled to the first set of multiplexer inputs; and
a second set of inverters comprising (i) a second set of inverter inputs that is coupled to the first multiplexer output and (ii) a second set of inverter outputs that is coupled to the second set of multiplexer inputs.

3. The apparatus of claim 2, wherein a challenge is applied to the first select input or the second select input.

4. The apparatus of claim 3, wherein the challenge comprises a select signal value that corresponds to a selection of a first inverter from the first set of inverter inputs and a second inverter from the second set of inverter inputs.

5. The apparatus of claim 4, wherein the first inverter and the second inverter are configured to generate a physically unclonable function (PUF) response that corresponds to the challenge.

6. The apparatus of claim 4, wherein the challenge comprises a length that corresponds to a quantity of inverters in the first set of inverters or the second set of inverters.

7. The apparatus of claim 2, wherein an inverter of the first set of inverters or the second set of inverters comprises a static random-access memory (SRAM) PUF circuit, wherein the SRAM PUF circuit comprises:
a transistor inverter circuit; and
an inverter cell comprising a p-channel metal-oxide-semiconductor (PMOS) transistor, an n-channel metal-oxide-semiconductor (NMOS) transistor, and output node, and a control signal input, wherein:
(i) the PMOS transistor comprises (a) a drain terminal that is coupled to an output and (b) a source terminal that is coupled to a supply voltage,
(ii) the NMOS transistor comprises a gate terminal that is coupled to a gate of the PMOS transistor that inhibits a path between the supply voltage and ground, and
(iii) responsive to a low state provided to the control signal input, the control signal input causes the PMOS transistor to charge the output node to the supply voltage.

8. The apparatus of claim 7, wherein the inverter further comprises a first multiplexing transistor and a second multiplexing transistor, wherein (i) the first multiplexing transistor comprises a first multiplexing transistor source terminal that is coupled to a drain terminal of the NMOS transistor and (ii) the second multiplexing transistor comprises a second multiplexing transistor drain terminal that is coupled to the transistor inverter circuit.

9. The apparatus of claim 8, wherein the inverter further comprises a first select transistor and a second select transistor that are configured to provide a select signal to the second multiplexing transistor.

10. The apparatus of claim 9, wherein the second multiplexing transistor comprises a second multiplexing transistor gate terminal that is coupled to (i) a first select transistor source terminal of the first select transistor and (ii) a second select transistor drain terminal of the second select transistor.

11. The apparatus of claim 10, wherein the inverter further comprises a select signal that is coupled to (i) a first multiplexing transistor gate terminal of the first multiplexing transistor, (ii) a first select transistor gate terminal of the first select transistor, and (iii) a second select transistor gate terminal of the second select transistor.

12. The apparatus of claim 11, wherein the inverter further comprises an inverter activation system and a primitive pre-conditioning system.

13. The apparatus of claim 12, wherein the inverter activation system corresponds to functionality of the transistor inverter circuit via the first multiplexing transistor and the second multiplexing transistor based on the select signal.

14. The apparatus of claim 12, wherein the primitive pre-conditioning system comprises a pull-up pin that is configured to (i) force the output node to the supply voltage or (ii) isolate the output node from the supply voltage.

15. The apparatus of claim 12, wherein the primitive pre-conditioning system comprises a pull-down pin that is configured to (i) force the output node to the ground or (ii) isolate the output node from the ground.

16. An apparatus comprising:
an edge-triggered D flip-flop comprising:
a set of NAND gates that are configured in a cross-coupled configuration;
a pair of D-latch NAND gates; and
a pair of multiplexers that are configured in between the set of NAND gates and the pair of D-latch NAND gates, wherein a multiplexer of the pair of multiplexers comprises:
a multiplexer output that is coupled to a first D-latch NAND input of a first D-latch NAND gate of the pair of D-latch NAND gates;
a first multiplexer input that is coupled to a NAND output from the set of NAND gates,
a second multiplexer input that is coupled to (a) a second D-latch NAND input of the first D-latch NAND gate and (b) a D-latch NAND output of a second D-latch NAND gate of the pair of D-latch NAND gates, and
a control signal that configures operation of the edge-triggered D flip-flop.
